(19) United States
(12) Patent Application Publication
(10) Pub. No.: US 2004/0011965 A1
(43) Pub. Date: Jan. 22, 2004

(54) Method and apparatus for detecting chemical contamination

(76) Inventor: Elizabeth Jane Hodgkinson, Leicestershire (GB)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/344,417

(22) PCT Filed: Aug. 14, 2001
(86) PCT No.: PCT/GB01/03620

(30) Foreign Application Priority Data
Aug. 18, 2000 (GB) 0020354.7
Jan. 30, 2001 (GB) 0102309.2

(51) Int. Cl. G01N 21/64

(52) U.S. Cl. 250/461.1; 356/317

(57) ABSTRACT

The method detects the presence of poly-chlorinated biphenyls on a surface, by the use of UV fluorescence spectroscopy in the back-emitting mode. The apparatus comprises a source of UV radiation. Exposure means are provided for conveying UV radiation from the source to the surface. Collecting means collect radiation back-emitted from the surface. A filter filters the collected radiation, and a spectrometer analyses the filtered collected radiation. The filter allows radiation having a wavelength within the range of from 320 nm to 360 nm to pass to the spectrometer.

### FIELD OF THE INVENTION

The present invention relates to a method of detecting chemical contamination, and in particular for detecting, and optionally measuring, the presence of polychlorinated biphenyls on a surface. The invention also relates to an apparatus for carrying out the method.

### BACKGROUND OF THE INVENTION

Poly-chlorinated biphenyls (PCBs) are highly inert, oily liquids that are known to contaminate certain gas distribution systems. They are believed to originate from the use of PCB-containing lubricants in compressors, and/or fogging of pipelines with PCB-containing oil vapour. US EPA has issued management regulations such that pipelines with PCB levels of less than 50 ppm may continue to be used, while those with levels of greater than 500 ppm are not to be used.

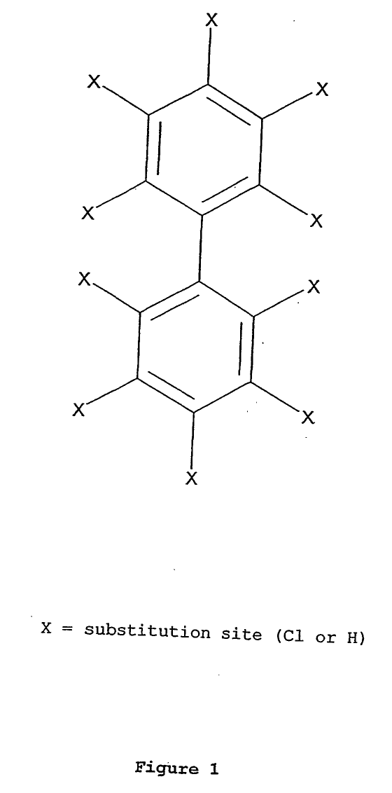

PCBs are known human carcinogens. They have a general chemical structure as shown in FIG. 1. It is known that there are 209 separate chemical species, differing in the number of chlorine atoms found at each substitution site, and the precise locations of these sites.

PCBs have been manufactured by a number of companies as the “Aroclor” and “Clophen” ranges. These substances are actually blends of a number of different individual PCB chemicals, covering a range of levels of chlorination. For example, Aroclor 1254 contains approximately 100 individual components, with chlorination levels ranging from two atoms per molecule to eight.

A known method of measuring PCB levels inside pipes is described as follows. A solvent-loaded swab is rubbed over a 10 cm×10 cm area on the inner surface of the pipe. The swab is allowed to air dry and then sealed in a container. The swab is analysed at a central laboratory, using US EPA method 8082. Solvent extraction followed by high performance liquid chromatography (HPLC) determines the level of PCB. Therefore, a quoted PCB level of 50 μg means that 50 μg of PCB were found with this method on this inner area.

During analysis, PCB blends are likely to exhibit a range of behaviours associated with the number and location of chlorine atoms present. Because the original manufacturing process was not perfectly controlled, this means that batch-to-batch variation is possible and that the “Aroclor 1254” in one pipeline might differ from the “Aroclor 1254” in another.

Because the source and the precise blend of the PCB contamination can be unknown, various analytical standards have been adopted. One such blend includes examples of every level of chlorination, while another uses EPA recognised substituents. This makes quantitative, rather than qualitative, testing very difficult.

Furthermore, it is desirable to detect the PCBs in the presence of other contaminants likely to be found in the same location. For example, gas pipes are likely to be contaminated with a range of both aromatic and aliphatic organic compounds plus inorganic material (some of which may fluoresce in the UV). Whether PCBs, which are complex mixtures of chemicals with unknown levels of batch-to-batch variation, may be determined against an even more complex and variable background, has not previously been established.

A number of instruments using time-resolved UV fluorescence spectroscopy are known for detection of aromatic compounds including the BTEX compounds (benzene, toluene, ethyl benzene and xylene) and poly-aromatic hydrocarbons (PAHs), which can leach into soil and water from petroleum, and recently PCBs. While the detection of these chemicals in ppm quantities in a 1 cm×1 cm cuvette is quite feasible by this method, and even ppb levels can be detected with some care, time-resolved fluorescence spectroscopy is costly. This is mainly due to the need for a UV laser emitting nanosecond light pulses and the associated electronics needed to provide time resolution on the nanosecond scale.

There is therefore a need to detect and optionally quantify the level of chemical contamination in difficult to access places, such as the inside of pipelines, at lower costs.

### SUMMARY OF THE INVENTION

We have found that this objective can be achieved by a method based on the use of UV spectroscopy in either a back-emitting mode (sometimes incorrectly termed the “reflective mode”) or with emitter and detector arranged substantially at right angles, to detect and possibly identify chemicals by analysing emitted light.

Thus, according to a first aspect of the invention, there is provided a method of detecting the presence of poly-chlorinated biphenyls on or in a sample (or carried by a sample), comprising the use of UV fluorescence spectroscopy.

Also, according to a second aspect of the invention, there is provided an apparatus for detecting the presence of poly-chlorinated biphenyls on or in a sample (or carried by a sample), comprising a source of UV radiation, exposure means for conveying UV radiation from the source to the sample, collecting means for collecting radiation emitted from the sample, a filter for filtering the collected radiation, and means for analysing the filtered collected radiation, characterised in that the filter allows radiation having a wavelength within the range of from 320 nm to 360 nm to pass there-through to be analysed.

The invention demonstrates the principle of using UV fluorescence spectroscopy in the back-emitting mode to determine PCBs against a complex background of other contaminants. This method is simpler and less costly than other more complicated alternatives.

Compared to the use of a swab test with US EPA method 8082, a field UV fluorimeter offers a standardised approach with less opportunity for operator error, as well as turnaround times of the order of minutes rather than days.

While UV fluorescence spectroscopy is a well-known technique for analysis, operating in back-emitting mode on surfaces or acting through liquid samples (usually the emission is measured perpendicular to the excitation beam), it has not previously been proposed for the detection, and optional measurement, of PCBs, nor for the analysis of the inner surfaces of pipe walls.

The method according to the invention preferably comprises exposing the sample to radiation from a UV light source, filtering the radiation emitted from the sample, and subjecting the filtered emitted radiation to spectral analysis. The sample may be exposed to radiation having a band width of less than 10 nm. The sample maybe exposed to radiation having a peak emission within the range 215 to 270 nm, especially 215 to 260 nm. The spectral analysis is preferably carried out at a resolution of less than 10 nm. It is preferred that the spectral analysis is carried out over at least one wavelength band within the range from the peak emission wavelength of the exposing radiation to 450 nm. The means for analysing the filtered collected radiation is preferably a spectrometer.

Where the sample is suspected of contamination with another contaminant, spectral analysis is preferably carried out over at least two wavelength bands, being (i) a first band within the range of 320 to 360 nm; (ii) a second band within which fluorescence from PCB is not expected. The second band may lie within the range of 300 to 320 nm or 360 to 430 nm. A third measurement maybe made of the peak emission from the UV light source, either using a non-dispersive measurement or by using a spectrometer. This third measurement is particularly useful if the intensity of the output of the light source cannot be relied upon to be constant.

The collecting means preferably includes optical fibres extending from a vicinity of the sample to the spectrometer. Similarly, the exposure means preferably includes optical fibres extending from the source to the vicinity of the sample. Means other than optical fibres may be employed for transferring excitation light or emitted light, for example, free space could be used if there is a line of sight or a system of reflecting objects such as mirrors.

The apparatus may be adapted for detecting the presence of poly-chlorinated biphenyls on the inside surface of a pipe, wherein the exposure means and the filter are housed in a common probe positioned in the pipe, the spectrometer is located outside the pipe, and an optical fibre or fibre bundle connects the two.

The apparatus according to the invention may be in the form of a hand-held instrument or field-portable apparatus having a probe or head that interrogates the sample. The probe can be inserted partly or completely into a gas main containing gas (live) or not (dead) using known methods of inserting probes or the like into mains. An optical fitting is positioned at a wall or opening of the pipe and is optically coupled to the probe and to the spectrometer by the optical fibres.

Alternatively, the probe may be fixed permanently to a gas main. The remainder of the apparatus can be connected up to the probe as and when detection and/or measurements are required to be determined.

A number of well-known spectral analysis methods may be used to interpret contaminated and uncontaminated spectra, improving signal to noise ratios.

Methods of analysis for PCBs against a range of other chemicals could include the following:

(i) Using a number of narrow band optical transmission filters with peak transmission (a) between 320 nm and 360 nm (to determine PCB level), (b) between 300 nm and 320 nm and/or 360 nm and 430 nm (reference for other pipe contaminants), and (c) overlapping with the peak excitation source, (second reference measurement).

(ii) Using well-known spectroscopic pattern matching algorithms, such as principal components regression analysis, to fit the broad spectral bands for the components (PCB contaminant, and other contaminants) to the measured fluorescence spectrum.

(iii) Measuring the total UV fluorescence in the region 320 to 360 nm and comparing it to the total fluorescence in a second region or regions from 300 to 320 nm and/or from 360 to 430 nm.

This invention may also be of use for detecting PCB contamination in many other gas related sites, allowing determination of PCBs for example around the compressor stations themselves and on contaminated land around gasholders.

The invention will now be further described, purely by way of example, with reference to the accompanying drawings, in which:

FIG. 1 shows the generic chemical structure of poly-chlorinated biphenyls;

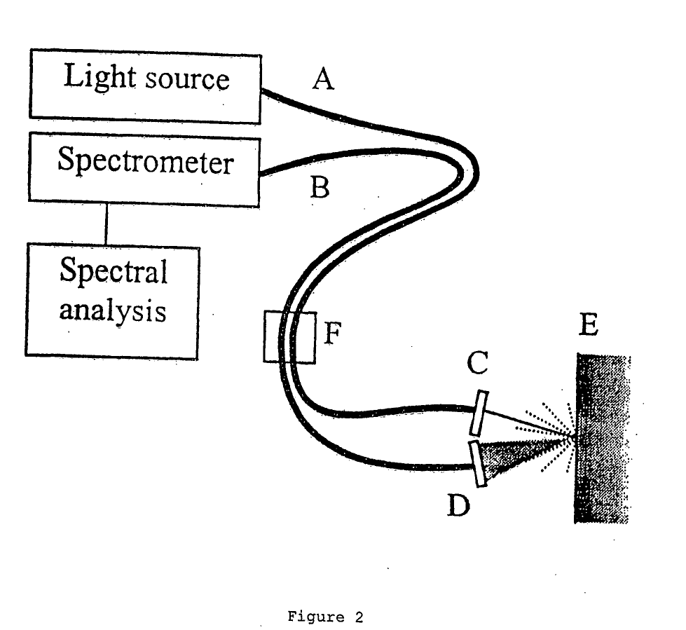

FIG. 2 shows an embodiment of an apparatus for detecting the presence of PCBs on a surface;

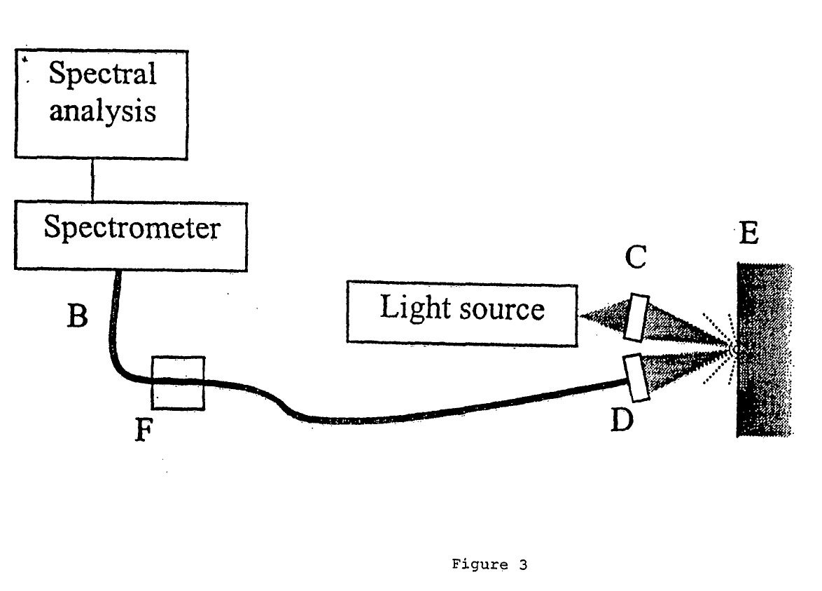

FIG. 3 shows an alternative embodiment of an apparatus for detecting the presence of PCBs on a surface;

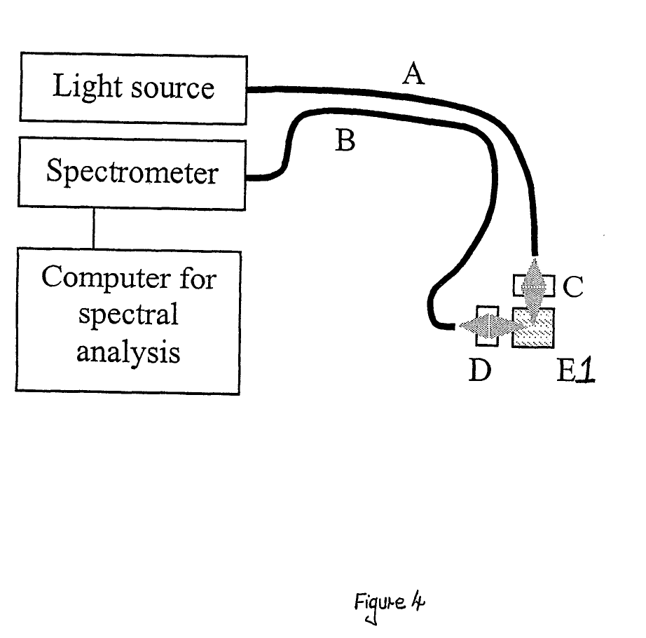

FIG. 4 shows an embodiment of an apparatus for detecting the presence of PCBs within a liquid sample;

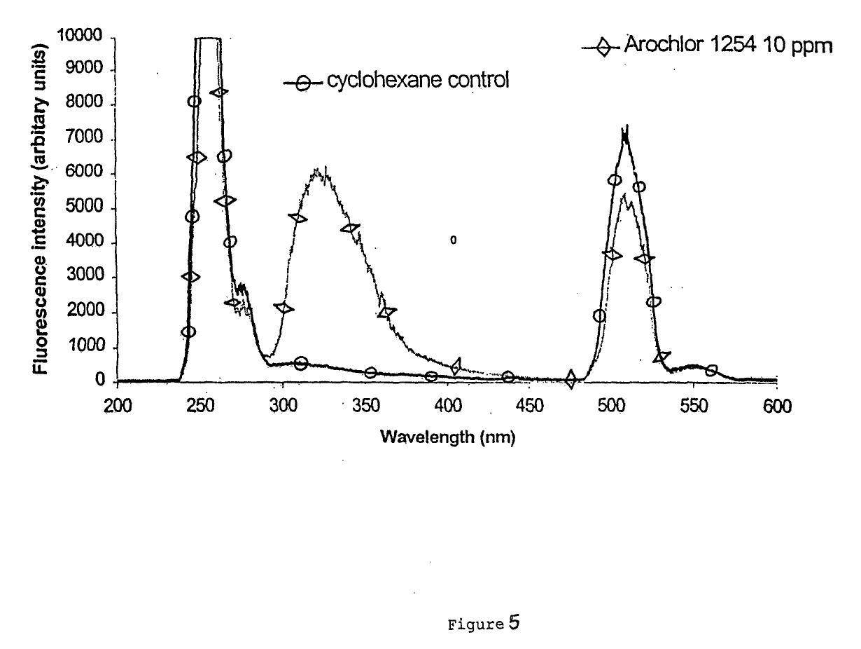

FIG. 5 shows the fluorescence spectra from samples of Aroclor 1254 in cyclohexane, taken using a spectrometer with a 10 nm slit width;

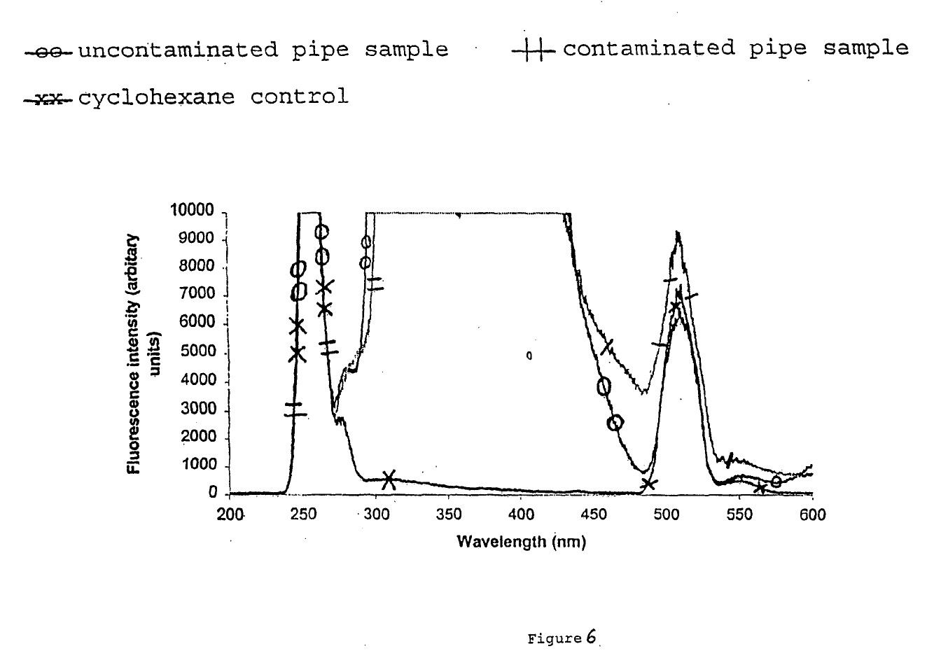

FIG. 6 shows fluorescence spectra from contaminated and uncontaminated pipe samples, taken using the spectrometer in the same configuration as for FIG. 5; and

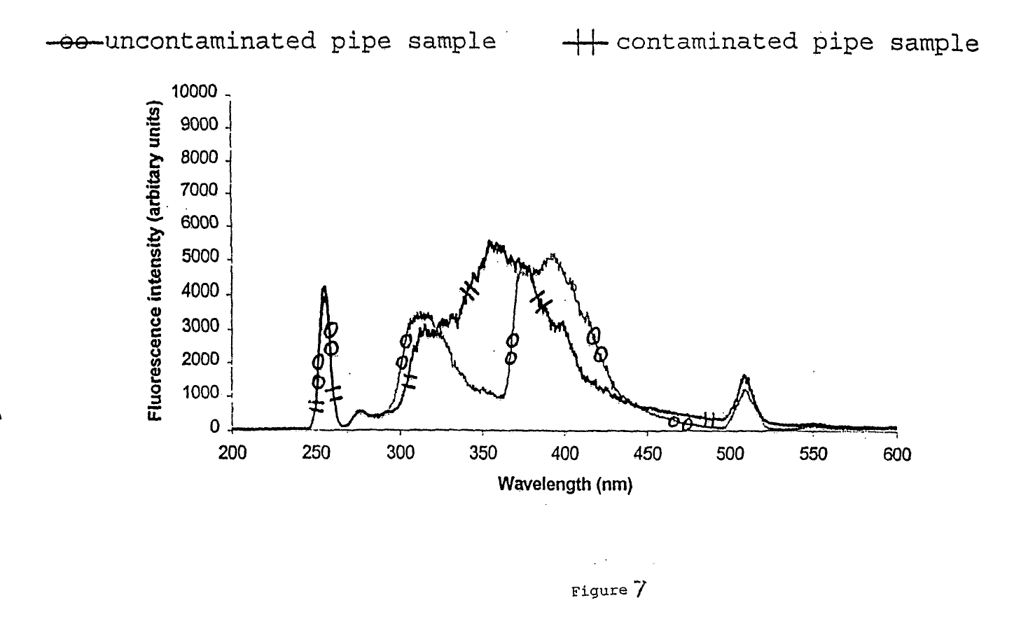

FIG. 7 shows fluorescence spectra from contaminated and uncontaminated pipe samples, taken with the spectrometer using narrower slits to give lower sensitivity.

Referring to FIG. 2, A and B are (preferably but not necessarily) optical fibres or optical fibre bundles. The fibres are preferably separate but the excitation light from the source and emitted light from sample E could possibly travel down the same optical fibre(s), being coupled from the light source or into the spectrometer using a splitter. It is possible that A and B may comprise separate individual fibres making up a single fibre bundle.

C and D are preferably filters and/or focusing optics. C allows only the excitation light to pass through and, for example, prevents the transmission of fluorescence originating in fibre A. D allows only fluorescence to pass and prevents the transmission of excitation light into fibre B. This limits the formation of additional fluorescence in fibre B. Parts C and D preferably also contain focusing optics to concentrate the light intensity onto the surface of sample E and maximise the collection efficiency of light emanating from the surface. Parts C, D and the ends of the fibre bundles A and B form the probe that interrogates the sample surface.

E, the sample under test, may be the inside surface of a pipe or vessel, another contaminated item, or a piece of contaminated land. Sample E could also be a liquid that either is located at a distance from the probe tip or actually in contact with it, such that the contents of the liquid can be analysed for possible contamination.

F is an optional fitting that allows the probe to be placed inside difficult to access places (such as pipes or vessels) under live conditions.

The light source should emit preferably UV light with a bandwidth preferably less than 10 nm and a peak emission of between 215 and 270 nm. The peak is preferably between 240 and 260 nm. The excitation source could, however, simply be a broad-band source with a “white” spectrum, such as a deuterium lamp or xenon lamp. Such a source preferably has a filter to selectively transmit the wavelengths indicated above.

The spectrometer should have a resolution preferably narrower than 10 nm and be capable of measuring spectra between the peak emission wavelength and 450 nm. The spectrometer could simply consist of a series of narrow bandwidth optical filters but would ideally be a spectrometer (e.g. diode array) with a resolution of 2 nm or less. Preferably the spectrometer should measure spectra between 290 nm and 450 nm and include a measurement of the excitation intensity. The shape of the spectrum then relates to the identification of PCBs against a background of other contaminants. The magnitude of the spectrum then relates to the amount of PCB on the pipe wall, up to a certain level where the signal saturates because all the excitation light has been absorbed.

Referring to FIG. 3, the light source is located inside the pipe so that an optical fibre link between the light and the pipe wall is not necessary.

It would also be possible for the spectrometer unit to be located inside the pipe, especially if it consisted simply of a number of narrow band filters and detectors.

An advantage of the apparatus described above in relation to FIGS. 2 and 3 is that they enable PCBs to be determined in difficult to access, possibly pressurised places (e.g. pipes or vessels) under live conditions, with minimum disruption. Contaminants may be determined either on the inner or outer surface of the pipe or vessel, or in the contents of that pipe or vessel.

Referring to FIG. 4, in which the apparatus for detecting PCBs is configured for analysing a liquid, the emitter and detector ends of the optical fibres or optical fibre bundles, A and B, connected to the light source and spectrometer, respectively, are arranged substantially at right-angles to each other and in relation to a container, for example a cuvette E1, that contains the liquid sample to be analysed. Instead of being in a container, the liquid to be analysed may be free flowing liquid.

The detection of PCBs according to the invention is illustrated by the following Examples.

### EXAMPLE 1

In this example, fluorescence spectra were analysed using a Hitachi F4500 fluorescence spectrophotometer.

FIG. 5 shows the fluorescence spectra from samples of Aroclor 1254 in cyclohexane, taken using a spectrometer with a 10 nm slit width. Strong peaks at 254 nm and 508 nm can be seen, resulting from scattering of light from the excitation source. The peak at 320 nm derives from the Aroclor, while there is no peak at this wavelength derived from the cyclohexane control. This Figure shows that detection of 10 ppm Arochlor in cyclohexane is indeed possible.

### EXAMPLE 2

Experiments were conducted to determine discrimination between contaminated and uncontaminated pipes. Samples of contaminated and uncontaminated pipe were obtained from a gas distribution utility. The contaminated pipe had approximately 300 μg of Aroclor 1260 over a 100 cm² area, according to the method of analysis outlined in “US EPA method 8082”.

Solid samples were removed from each pipe wall and the chemicals in them allowed to leach into solution in 100 ml of cyclohexane. A bulk sample was scraped with a scalpel from an area of approximately 1 cm² of each pipe wall. The dirt layer on the contaminated pipe was a fraction of a millimetre thick, all of which was scraped off with the scalpel. In contrast, the dirt layer on the uncontaminated pipe was between 1 mm and 2 mm thick, of which approximately 1 mm was scraped off. The solid scraping was in each case added to a 100 ml flask of cyclohexane and left for a period of six days in the dark prior to analysis. Therefore, the solution prepared from the uncontaminated pipe contained a greater mass of dirt layer than that prepared from the contaminated pipe.

The level of PCB in the cyclohexane leachate was estimated by making a number of assumptions, as follows:

(i) the level of PCB contamination was uniform across the entire pipe wall;

(ii) the method of analysis in “US EPA-method 8082” determined the total amount of PCB in the dirt layer on the pipe wall, not just that at the surface.

(iii) all the PCB from the scraped dirt layer subsequently leached into solution in the cyclohexane.

If these assumptions hold, then a 1 cm² scraping from the pipe wall would contain 3 μg of Aroclor 1260, resulting in a concentration of 30 ppb in cyclohexane.

FIG. 6 shows fluorescence spectra from contaminated and uncontaminated pipe samples, taken using the spectrometer in the same configuration as for FIG. 5. It should be noted that the strong fluorescence has saturated the detector between 300 nm and 450 nm in both cases.

FIG. 7 shows fluorescence spectra from contaminated and uncontaminated pipe samples, taken with the spectrometer using narrower slits. The spectra in FIG. 7 cannot be compared directly with those in FIGS. 5 and 6, because of the lower sensitivity. The spectra in FIG. 7 should be judged qualitatively, since the basic samples contained different thicknesses of dirt layer from the pipe wall. There is a clear difference between the spectra for the uncontaminated and contaminated pipe samples. The additional fluorescence from the contaminated sample, between 320 nm and 360 nm, lies in approximately the same place as the fluorescence peak for the pure sample of Aroclor 1254. This indicates that there is sufficient information in these spectra to reliably determine PCB contamination against other chemical contaminants found in gas pipes.

It will be noted that, in Example 2, the pipe was contaminated with Aroclor 1260, whilst in Example 1 the pure sample analysed was Aroclor 1254. There is a high degree of overlap between the sets of different chemical congeners present in each Aroclor, so it is reasonable to assume that Aroclor 1260 behaves in a very similar way to Aroclor 1254.

UV absorption and fluorescence spectra from liquid samples contain naturally broad absorption bands and so have a low information content, making it difficult to determine complex mixtures. It is therefore surprising that there should be sufficient information in the fluorescence spectrum to separately identify a contaminated and uncontaminated pipe. It is also surprising that the gap between fluorescence peaks from the uncontaminated pipe should coincide with the fluorescence peak due to PCB contamination. This allows accurate determination of PCBs against this complex background of other chemical contaminants.

1. A method of detecting the presence of poly-chlorinated biphenyls on or in a sample, comprising the use of UV fluorescence spectroscopy.

2. A method according to claim 1, comprising exposing said sample to radiation from a UV light source, filtering the radiation emitted from said sample and subjecting said filtered emitted radiation to spectral analysis.

3. A method according to claim 2, wherein said sample is exposed to radiation having a band width of less than 10 nm.

4. A method according to claim 2 or 3, wherein said sample is exposed to radiation having a peak emission within the range 215 to 270 nm.

5. A method according to any one of claims 2, 3 or 4, wherein said spectral analysis is carried out at a resolution of less than 10 nm.

6. A method according to any one of claims 2 to 5, wherein said spectral analysis is carried out over at least one wavelength band within the range from the peak emission wavelength of the exposing radiation to 450 nm.

7. A method according to claim 6, wherein said sample is suspected of contamination with another contaminant, and wherein spectral analysis is carried out over at least two wavelength bands, being (i) a first band within the range of 320 to 360 nm; and (ii) a second band within which fluorescence from said PCB contaminant is not expected.

8. A method according to claim 7, wherein said second band lies within the range of 300 to 320 nm or 360 to 430 nm.

9. A method according to any of claims 1 to 8, wherein said sample is a liquid.

10. A method according to any of claims 1 to 8, wherein said sample is the surface of a solid.

11. An apparatus for detecting the presence of poly-chlorinated biphenyls on or in a sample, comprising a source of UV radiation, exposure means for conveying UV radiation from said source to said sample, collecting means for collecting radiation emitted from said sample, a filter for filtering said collected radiation, and a spectrometer for analysing the filtered collected radiation, characterised in that said filter allows radiation having a wavelength within the range of from 320 nm to 360 nm to pass to said spectrometer.

12. An apparatus according to claim 11, wherein said collecting means includes optical fibres extending from a vicinity of said sample to said spectrometer.

13. An apparatus according to claim 11 and 12, wherein said exposure means includes optical fibres extending from said source to the vicinity of said sample.

14. An apparatus according to claims 12 and 13, adapted for detecting the presence of poly-chlorinated biphenyls on the inside surface of a pipe, wherein said exposure means and said filter are housed in a common probe positioned in said pipe, said spectrometer is located outside said pipe, and an optical fitting is positioned in a wall of the pipe and is optically coupled to said probe and to said spectrometer by said optical fibres.

15. An apparatus according to claim 14, wherein said probe is adapted for insertion into a gas main under live conditions.

16. An apparatus according to any of claims 11 to 15, wherein the spectrometer is configured for detection of back-emitted radiation from the sample.

17. A method of detecting the presence of poly-chlorinated biphenyls on a surface, substantially as hereinbefore described, with reference to the accompanying examples.

18. An apparatus for detecting the presence of poly-chlorinated biphenyls on a surface, substantially as hereinbefore described, with reference to the accompanying drawings.
